(19) United States
(12) Patent Application Publication
(10) Pub. No.: US 2016/0273255 A1
(43) Pub. Date: Sep. 22, 2016

(54) POP-UP MECHANISM OF DOOR FOR VEHICLE

(71) Applicant: AISIN SEIKI KABUSHIKI KAISHA, Kariya-shi, Aichi-ken (JP)

(72) Inventors: Shintaro SUZUKI, Kariya-shi (JP); Tomokazu SEKI, Kariya-shi (JP)

(73) Assignee: AISIN SEIKI KABUSHIKI KAISHA, Kariya-shi, Aichi-ken (JP)

(21) Appl. No.: 15/032,439

(22) PCT Filed: Sep. 17, 2014
(86) PCT No.: PCT/JP2014/004766

§ 371 Date: Apr. 27, 2016

(30) Foreign Application Priority Data
Oct. 29, 2013 (JP) 2013-224058

(51) Int. Cl. E05F 1/10; B60J 5/04

(52) U.S. Cl. CPC E05F 1/10; B60J 5/047; E05Y 2201/47; E05Y 2900/531

(57) ABSTRACT

A pop-up mechanism of a door for a vehicle includes a first member configured to be supported at a vehicle body and to transmit a force to a door for a vehicle, a second member configured to store an external force applied to the second member and to transmit the force that is stored to the first member, and a trigger member releasing the force stored by the second member, the first member opening the door for the vehicle based on the force stored by the second member in a case where the trigger member releases the force stored by the second member.

### TECHNICAL FIELD

The present invention relates to a pop-up mechanism for opening a door for a vehicle.

### BACKGROUND ART

A vehicle generally includes a door latch apparatus for locking a door for a vehicle at a fully closed position. In a case of opening the door, a user operates a door handle so as to release the locking of the door caused by the door latch apparatus and pulls the door handle, for example, so as to open the door.

In a case where the user's both hands are full with luggage, for example, it is difficult for the user to operate the door. Therefore, according to Patent document 1, an automobile door control apparatus is proposed for opening the door based on a release of the user's hand from the door handle, for example, so as to smoothly open the door even when the user's both hands are full.

### DOCUMENT OF PRIOR ART

### Patent Document

Patent document 1: Japanese Patent Application Publication 2008-2085

### OVERVIEW OF INVENTION

### Problem to be Solved by Invention

The present invention provides a pop-up mechanism of a door for a vehicle, which improves operability of the door by enabling a user to easily operate the door to open even in a case where the user is in a difficult situation for opening the door as mentioned above.

### Means for Solving Problem

That is, the present invention provides the pop-up mechanism including a first member configured to be supported at a vehicle body and to transmit a force to a door for a vehicle, a second member configured to store an external force applied to the second member and to transmit the force that is stored to the first member, and a trigger member releasing the force stored by the second member, the first member opening the door for the vehicle based on the force transmitted from the second member in a case where the trigger member releases the force stored by the second member.

With the aforementioned construction, according to the pop-up mechanism that is provided, the force stored by the second member is released by the trigger member so as to be transmitted to the first member. Based on the stored force, the first member may open the door for the vehicle. Thus, even in a difficult situation for operating the door, a user may open the door with a simple operation for operating the trigger member to thereby easily open the door. Operability of the door is thus enhanced.

The further feature of the present invention is clarified by an explanation of the following embodiments serving as exemplary indications with reference to the attached drawings.

### BRIEF DESCRIPTION OF DRAWINGS

FIG. 1 is a schematic view of a vehicle including a pop-up mechanism according to a first embodiment of the present invention;

FIG. 2 is a schematic view of the pop-up mechanism according to the first embodiment of the present invention;

FIG. 3A illustrates a first opening operation position of a door;

FIG. 3B illustrates a second opening operation position of the door;

FIG. 3C illustrates a third opening operation position of the door;

FIG. 4A illustrates an operation of the pop-up mechanism according to the first embodiment of the present invention;

FIG. 4B illustrates an operation of the pop-up mechanism according to the first embodiment of the present invention;

FIG. 4C illustrates an operation of the pop-up mechanism according to the first embodiment of the present invention;

FIG. 5 illustrates a modified example of the pop-up mechanism including a pneumatic cylinder according to the first embodiment of the present invention;

FIG. 6 illustrates a modified example of a construction of a pawl in the pop-up mechanism according to the first embodiment of the present invention;

FIG. 7 is a block diagram of a control portion and the like in a modified example of the pop-up mechanism according to the first embodiment of the present invention;

FIG. 8A illustrates an operation of a pop-up mechanism according to a second embodiment of the present invention;

FIG. 8B illustrates an operation of the pop-up mechanism according to the second embodiment of the present invention;

FIG. 9A illustrates an operation of a pop-up mechanism according to a third embodiment of the present invention; and

FIG. 9B illustrates an operation of the pop-up mechanism according to the third embodiment of the present invention.

### MODE FOR CARRYING OUT THE INVENTION

Hereinafter, exemplary embodiments for achieving the present invention are explained in detail with reference to drawings. Dimensions, materials, configurations and relative positions between components, for example, explained in the following embodiments are arbitral and may be changed depending on a construction of an apparatus to which the present invention is applied and various conditions. In the drawings, the same reference numerals are employed among the drawings for illustrating the same or functionally similar components. In the present specification, an up-down direction corresponds to an upper direction and a lower direction in view of a gravity direction.

### First Embodiment

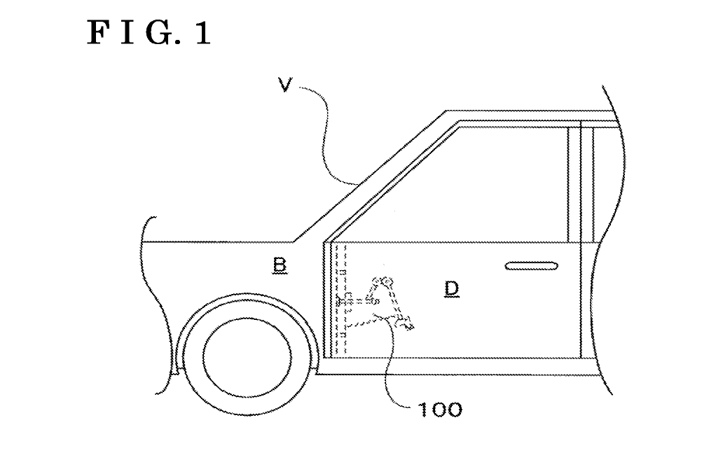

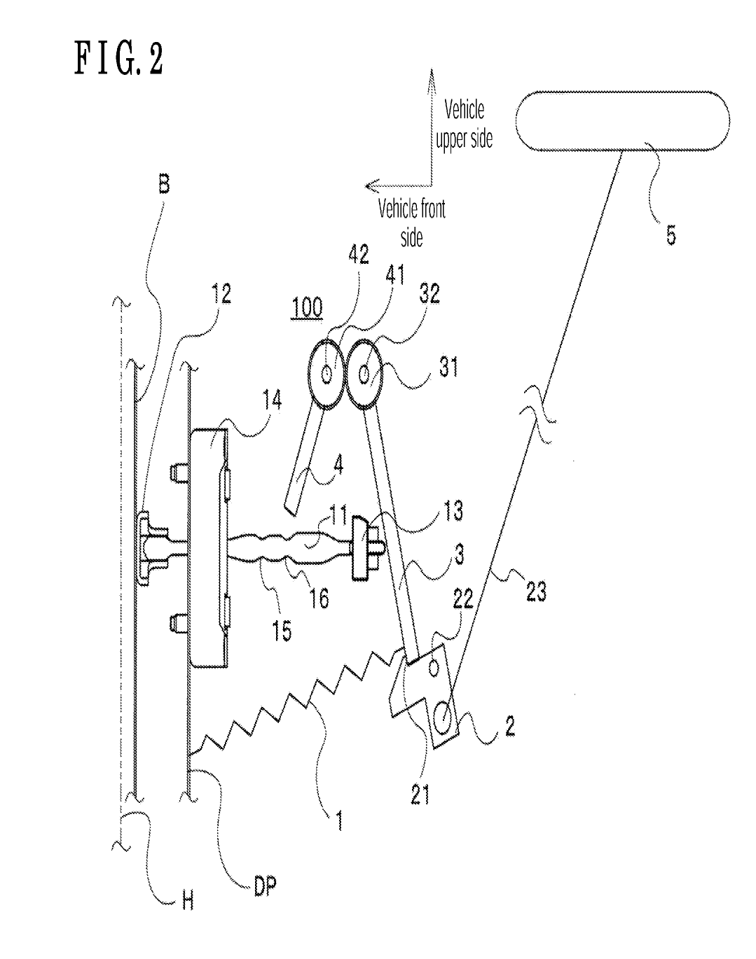

FIG. 1 is a schematic view of a vehicle V including a pop-up mechanism 100 according to a first embodiment of the present invention. As illustrated in FIG. 1, the pop-up mechanism 100 for opening a door D is provided within the door D in the vicinity of a connection portion between a vehicle body B of the vehicle V and the door D. FIG. 2 is a schematic view of the pop-up mechanism. For easily explanation, components at the inside of the door other than the pop-up mechanism 100 are omitted in FIG. 2. In FIG. 2, the vehicle body B, a door hinge shaft H, a door panel DP of the door D (FIG. 1) connected to the vehicle body B via a door hinge (not illustrated), a door handle 5 and the inside of the door D are illustrated. The pop-up mechanism 100 provided at the inside of the door D includes a check link 11, a spring 1, a pawl 2, first and second levers 3, 4 and first and second gears 31, 41. The pawl 2 is connected to the door handle 5 via a cable 23 to rotate about a rotation shaft 22. The first and second gears 31 and 41 may rotate about rotation shafts 32 and 42 respectively.

The check link 11 (first member) corresponds to a check link employed for a known door check mechanism. The check link 11 is supported at the vehicle body B to be rotatable thereto via a bracket 12. The check link 11 extends within the door D by passing through a door check 14 which is connected to the door panel DP. A stopper portion 13 is provided at an end portion of the check link 11 positioned within the door D. The stopper portion 13 makes contact with the door check 14 when the door D is opened to a fully open position so as to inhibit the door D from further opening. Grooves 15 and 16 are provided at the check link 11. In a case where a pressing body (not illustrated) of the door check 14 engages with each of the grooves 15 and 16, an opening operation position of the door D may be held at a position where each of the grooves 15 and 16 is provided.

The spring 1 (second member) is connected to the door panel DP and the first lever 3. The spring 1 stores an extending force in a case where the first lever 3 is moved in a direction separating from the check link 11. In the present embodiment, the spring 1 is configured to be directly connected to the door panel DP and the first lever 3. Instead, the spring 1 may be connected to the door panel DP and the first lever 3 via a member including a circular or polygonal configuration, for example.

A projection piece 21 is provided at the pawl 2 (trigger member). The projection piece 21 is fitted to the first lever 3 so as to support the first lever at a predetermined position at which the first lever 3 causes the spring 1 to store a force. The pawl 2 is connected to the door handle 5 via the cable 23 or a wire, for example. The pawl 2 is configured to rotate about the rotation shaft 22 with an operation of the door handle 5 for releasing an engagement of a door latch (not illustrated). The pawl 2 is configured by a spring not illustrated, for example, so as to automatically return to a position obtained before its rotation when the operation of the door handle 5 by a user is completed after the pawl 2 rotates with the operation of the door handle 5. In the present embodiment, the pawl 2 is configured to rotate. The trigger member, however, is not limited to the aforementioned construction and may be configured to slide, for example.

One end portion of the first lever 3 (first moving member) is connected to the spring 1. The other end portion of the first lever 3 is coupled to the first gear 31 (transmission member) which rotates about the rotation shaft 32. The first gear 31 is arranged to mesh with the second gear 41 (transmission member) rotating about the rotation shaft 42. The second lever 4 (second moving member) is coupled to the second gear 41. Therefore, the first lever 3 and the second lever 4 are configured to rotate (move) depending on each other's operation. The second lever 4 is configured so that an end thereof which is not coupled to the second gear 41 is in contact with the stopper portion 13 of the check link 11 until the check link 11 moves to reach a predetermined position after a pop-up operation of the door D. At this time, the pop-up operation corresponds to an opening operation of the door performed by the pop-up mechanism, specifically, corresponds to an opening of the door which is flipped up in an outward direction of the vehicle by a predetermined distance from a fully closed position to a position so that the user's hand is insertable into a void between the door and the vehicle body, for example. The direction in which the door is opened by being flipped up is a direction along a rotation direction of the door D. The transmission member that constitutes the first and second levers 3 and 4 to be movable depending on each other's operation is not limited to the first and second gears 31 and 41. The transmission member may be other member transmitting each other's operation of the first and second levers 3 and 4, for example, a belt connected to each of the rotation shafts 32 and 42 of the levers.

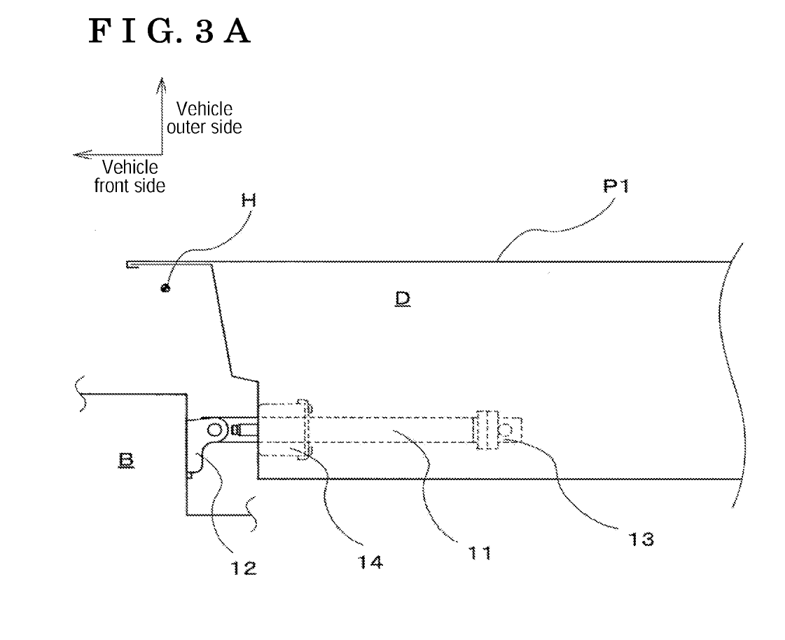

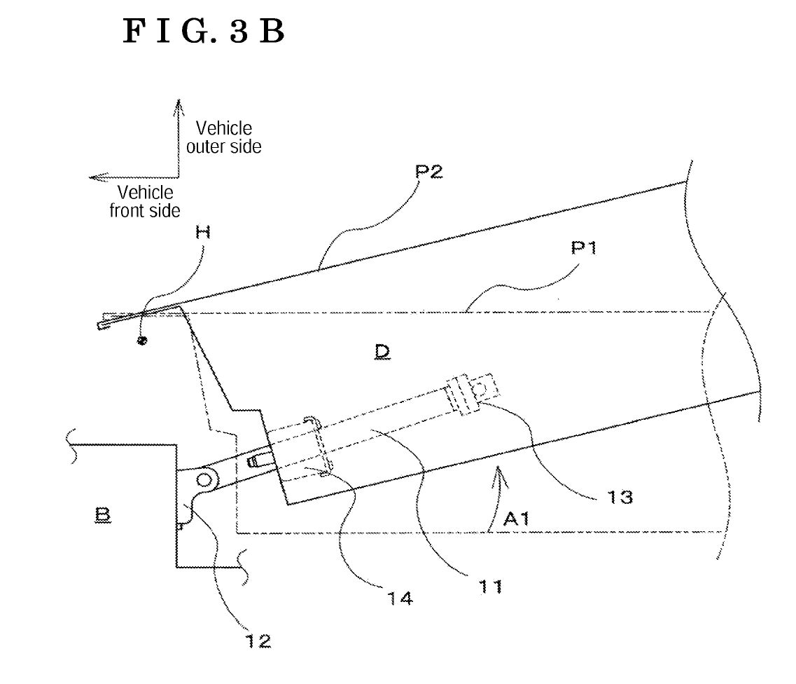

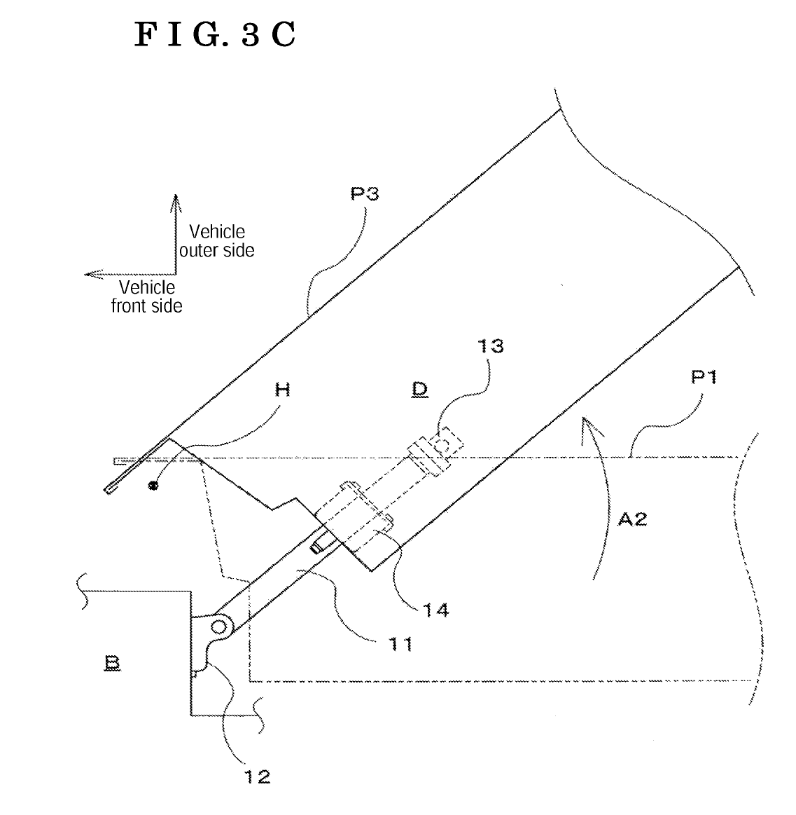

Next, operations of the door D and a door check mechanism are explained with reference to FIGS. 3A, 3B and 3C. FIGS. 3A, 3B and 3C are diagrams obtained when the connection portion between the vehicle body B and the door D is viewed from an upper side of the vehicle. FIG. 3A illustrates the door D arranged at a first opening operation position P1 serving as the fully closed position. FIG. 3B illustrates the door D arranged at a second opening operation position P2 serving as the opening operation position after the pop-up operation. FIG. 3C illustrates the door D arranged at a third opening operation position P3 serving as the opening operation position when an operation for causing the spring 1 of the pop-up mechanism 100 to store the force (hereinafter referred to as a “biasing”) is completed. In FIGS. 3B and 3C, the door D arranged at the first opening operation position P1 is indicated with alternate long and two short dashes line for easy understanding of the opening operation of the door D. The door D is opened to the second opening operation position P2 in a case where the door D performs the pop-up operation from the first opening operation position P1 serving as the fully closed position. The door D is thereafter opened by the user so as to be opened to the third opening operation position P3.

As illustrated in FIG. 3A, the check link 11 is rotatably supported at the vehicle body B via the bracket 12 at one end portion of the check link 11. The other end portion of the check link 11 extends to the inside of the door D by passing through the door check 14. At this time, the door D is supported at the vehicle body B via the door hinge not illustrated so that the door D may open with the hinge shaft H serving as a rotation shaft. In FIG. 3A where the door D is arranged at the fully closed position, it is understood that the door check 14 is positioned in the vicinity of the vehicle body B and a major portion of the check link 11 extends to the inside of the door.

Next, when the door D performs the pop-up operation, as illustrated in FIG. 3B, the door D opens to the second opening operation position P2 by opening in a direction separating from the vehicle body B along an arrow A1 from the first opening operation position P1 indicated with the alternate long and two short dashes line. At this time, based on the operation of the door D, the check link 11 is pulled out from the inside of the door. In response to the pulling-out of the check link 11, the pressing body (not illustrated) of the door check 14 engages with each of the grooves 15 and 16 of the check link 11. As a result, the door D may be held at a predetermined opening operation position based on the position at which each of the grooves of the check link 11 is provided.

FIG. 3C illustrates a state where the door D is further opened by the user. In FIG. 3C, the door D is opened to the third opening operation position P3 along an arrow A2 from the first opening operation position P1 indicated with the alternate long and two short dashes line. In FIG. 3C, it is understood that the check link 11 is further pulled out from the door D based on the operation of the door D. In a case where the door D is opened to the third opening operation position, the pop-up mechanism 100 of the embodiment may complete the biasing of the spring 1 which is explained later. Accordingly, with reference to FIGS. 3A, 3B and 3C, it is understood that the check link 11 which extends within the door D is pulled out from the door D based on the opening operation of the door D.

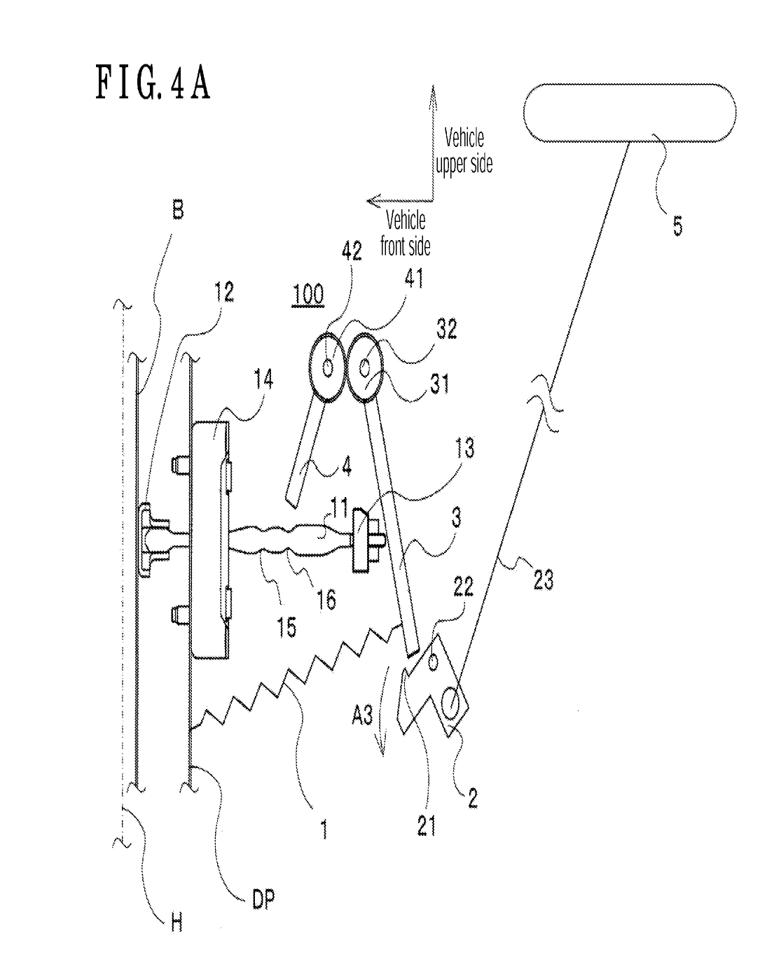

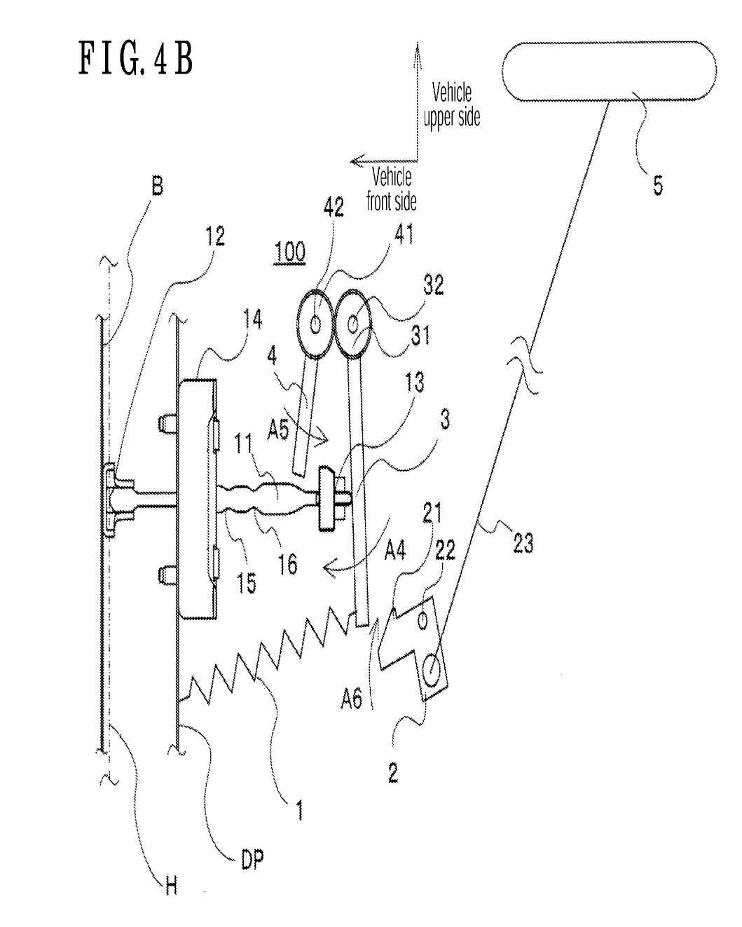

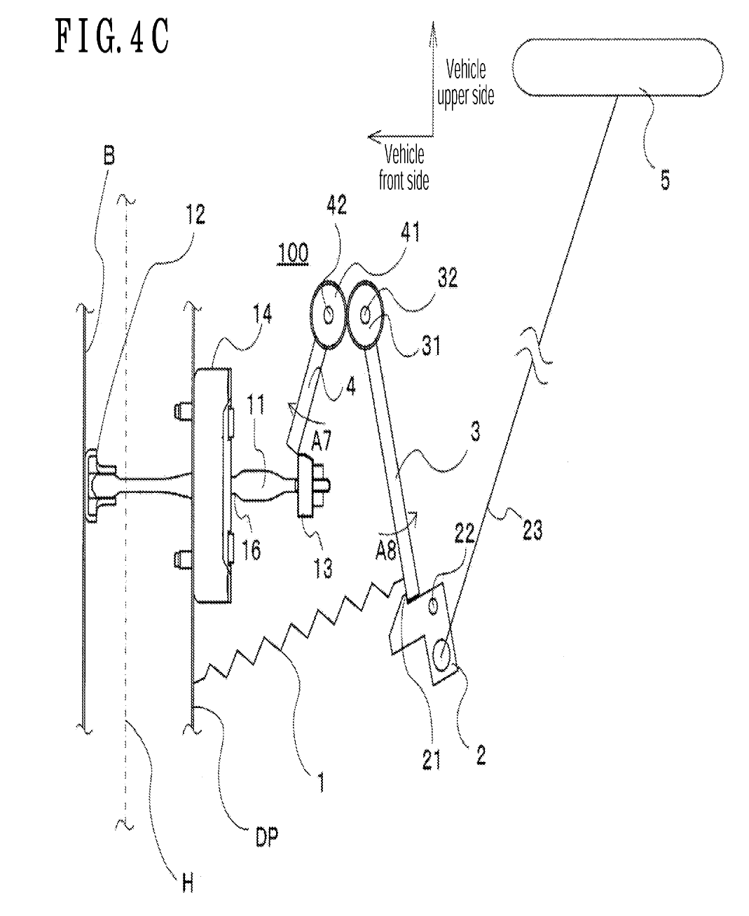

Next, the operation of the pop-up mechanism 100 of the embodiment is explained with reference to FIGS. 4A, 4B and 4C. FIGS. 4A, 4B and 4C illustrate the operation of the pop-up mechanism 100 of the embodiment. FIG. 4A illustrates the pop-up mechanism 100 where the pawl 2 is rotated in the door D which is arranged at the first opening operation position P1. FIG. 4B illustrates the operation of the pop-up mechanism 100 in association with the rotation of the pawl 2. According to the operation of the pop-up mechanism 100, the door D is opened to the second opening operation position P2. FIG. 4C illustrates the operation of the pop-up mechanism 100 in a case where the door D is further opened from the second opening operation position P2. The opening operation position at which the spring 1 completes its biasing serves as the third opening operation position P3.

In FIG. 4A, with the operation of the door handle 5, the pawl 2 rotates about the rotation shaft 22 along an arrow A3 in the door D which is arranged at the first opening operation position P1 serving as the fully closed position. Based on the rotation of the pawl 2, the fitting between the projection piece 21 of the pawl 2 and the first lever 3 is released within the pop-up mechanism 100.

In a case where the fitting between the projection piece 21 of the pawl 2 and the first lever 3 is released, as illustrated in FIG. 4B, the force stored by the spring 1 is released so that the spring 1 is contracted. In response to the contraction of the spring 1, the first lever 3 connected to the spring 1 moves along an arrow A4. Because of the aforementioned movement, the first lever 3 makes contact with a tip end of the stopper portion 13 of the check link 11 to push the check link 11. A pressing force applied to the check link 11 is transmitted to the vehicle body B which supports the check link 11. A reaction force generated at that time is added to the check link 11. The reaction force is transmitted to the door D from the door check 14 where the check link 11 passes through to thereby open the door D. In addition, in a case where the first lever 3 moves with the contraction of the spring 1, the operation of the first lever 3 is transmitted to the second lever 4 via the first and second gears 31 and 41 so that the second lever 4 moves along an arrow A5. Under such circumstances, the door D is opened to a predetermined position by the operation of the pop-up mechanism 100 so that the user may easily open the door D. The pawl 2, after its rotation, automatically returns to the position obtained before its rotation along an arrow A6 based on the completion of the operation of the door handle 5 by the user.

When the user further opens the door D, as illustrated in FIG. 4C, the stopper portion 13 of the check link 11 makes contact with the second lever 4 so that the second lever 4 moves along an arrow A7 based on the pulling-out operation of the check link 11. When the second lever 4 moves, the second gear 41 coupled to the second lever 4 rotates with the movement of the second lever 4, which causes the first gear 31 meshed with the second gear 41 to rotate. When the first gear 31 rotates, the first lever 3 coupled to the first gear 31 is operated to move along an arrow A8 to a position held by the pawl 2 with the extension of the spring 1 connected to the first lever 3. The condition at this time is illustrated in FIG. 4C. The pop-up mechanism 100 is operated in the aforementioned manner so that the biasing of the spring 1 for the next pop-up operation of the door D may be achieved without an intension of the user.

The pop-up mechanism 100 of the embodiment includes the check link 11 (first member) configured to be supported at the vehicle body B and to transmit the force to the door D, the spring 1 (second member) storing the external force applied to the spring 1, and the pawl 2 (trigger member) for releasing the force stored by the spring 1. Further, the pop-up mechanism 100 of the embodiment includes the first and second gears 31, 41 (transmission members) configured to mesh with each other, the first lever 3 (first moving member) and the second lever 4 (second moving member) which are coupled to the respective gears. In a case where the pawl 2 releases the force stored by the spring 1, the first lever 3 which is connected to the spring 1 pushes the check link 11 based on the aforementioned force. Thus, the spring 1 may transmit the stored force to the check link 11 via the first lever 3. The check link 11 may cause the door D to open based on the aforementioned force transmitted from the spring 1. Therefore, according to the pop-up mechanism 100 of the embodiment, the door D may be opened with a simple construction. The pop-up operation of the door D may be performed even under circumstances where the user's both hands are full, for example, which leads to easily opening of the door D. The pop-up mechanism 100 according to the first embodiment may improve operability of the door. In addition, because the pop-up mechanism 100 of the first embodiment includes a simple construction, a cost related to the pop-up mechanism may be reduced. Further, the second lever 4 makes contact with the check link 11 at a predetermined position after the pop-up operation of the door D. At this time, in a case where the check link 11 is pulled out from the door D based on the further opening operation of the door D, the second lever 4 moves with the operation of the check link 11, which rotates the second gear 41. When the second gear 41 rotates by the movement of the second lever 4, the first gear 31 which is meshed with the second gear 41 rotates so that the first lever 3 moves, which leads to the extension of the spring 1. As a result, the spring 1 may store the force. Thus, further opening the door D by the user from the opening operation position after the pop-up operation causes the external force to be applied to the spring 1 so that the spring 1 stores the force for the next pop-up operation of the door D. That is, the biasing of the spring 1 for the next opening operation of the door D by the pop-up mechanism 100 may be performed without the intension of the user.

It may be configured that the tip end of the stopper portion 13 of the check link 11 pushes the first lever 3 when the door D is closed so that the first lever 3 moves to a position at which the first lever 3 is held by the pawl 2 while the spring 1 is extending. According to the aforementioned construction, the external force is applied to the spring 1 by closing the door D by the user so that the spring 1 may store the force for the next pop-up operation of the door D. Thus, in the same way as the present embodiment, the biasing of the spring 1 for the next opening operation of the door D by the pop-up mechanism 100 may be performed without the intension of the user.

Further, the first member that causes the door D to open by transmitting the force stored by the spring 1 to the door D is not limited to the check link 11. For example, the other component supported at the vehicle body B separately from the door check mechanism and configured to transmit the force to the door D may be employed. For example, it may be a bar-formed member supported at the vehicle body B separately from the door check mechanism and configured to transmit the force to the door D via an arbitral member connected to the door D.

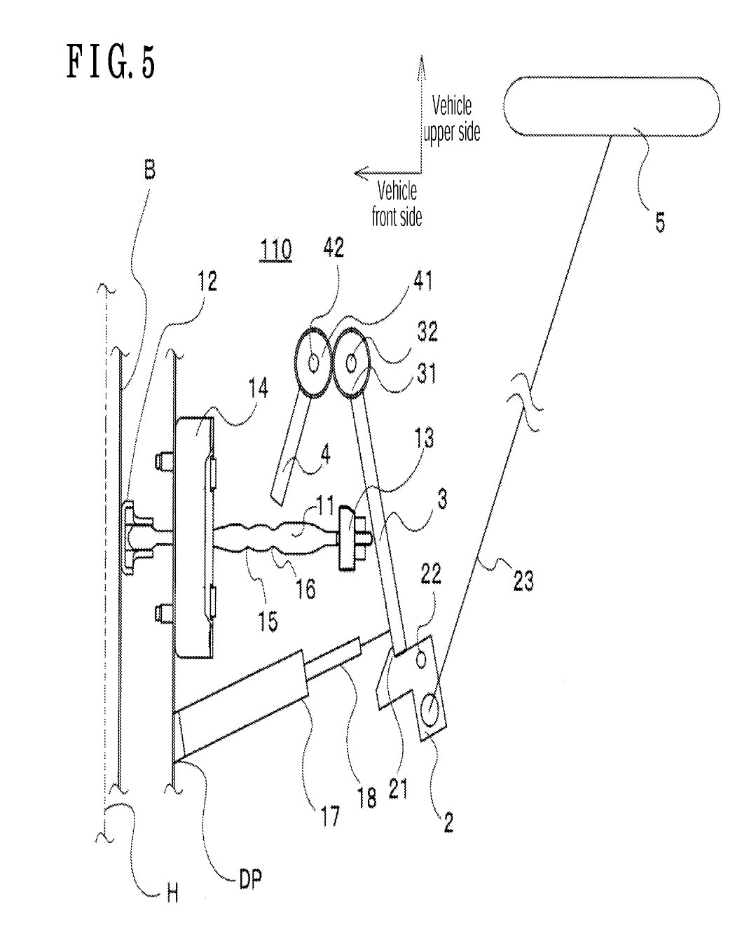

In the present embodiment, the spring is utilized as the second member. Alternatively, the other component than the spring storing the applied force, for example, an elastic body such as rubber and a pneumatic cylinder, may be utilized. Here, a pop-up mechanism 110 in a case where a pneumatic cylinder 17 is used as a modified example of the pop-up mechanism 100 is illustrated in FIG. 5. In the pop-up mechanism 110, the same constructions as those of the pop-up mechanism 100 bear the same reference numerals. The pneumatic cylinder 17 includes a piston rod 18 connected to a piston (not illustrated) which slides within the pneumatic cylinder 17. In the pop-up mechanism 100 illustrated in FIG. 5, the pneumatic cylinder 17 instead of the spring 1 is connected to the door panel DP and the piston rod 18 is connected to the first lever 3. The other constructions are the same as the pop-up mechanism 100 which employs the spring 1 as illustrated in FIG. 2. In this case, when the first lever 3 is held at a predetermined position by the pawl 2, the piston rod 18 is pulled out from the pneumatic cylinder 17. At this time, because an air pressure within the cylinder decreases in association with the operation of the piston rod 18, the pneumatic cylinder 17 stores a force for pulling back the piston rod 18 within the cylinder. Thus, when the holding of the first lever 3 is released, the pneumatic cylinder 17 pulls back the piston rod 18 into the cylinder based on the stored force. The first lever 3 moves on a basis of the operation of the piston rod 18 that is pulled back and makes contact with the check link 11 to press the check link 11. The other operation is the same as the pop-up mechanism 100 which employs the spring 1. Accordingly, in a case where the pneumatic cylinder 17 is utilized, the door is opened by the pop-up mechanism 110 and the user may easily operate the door.

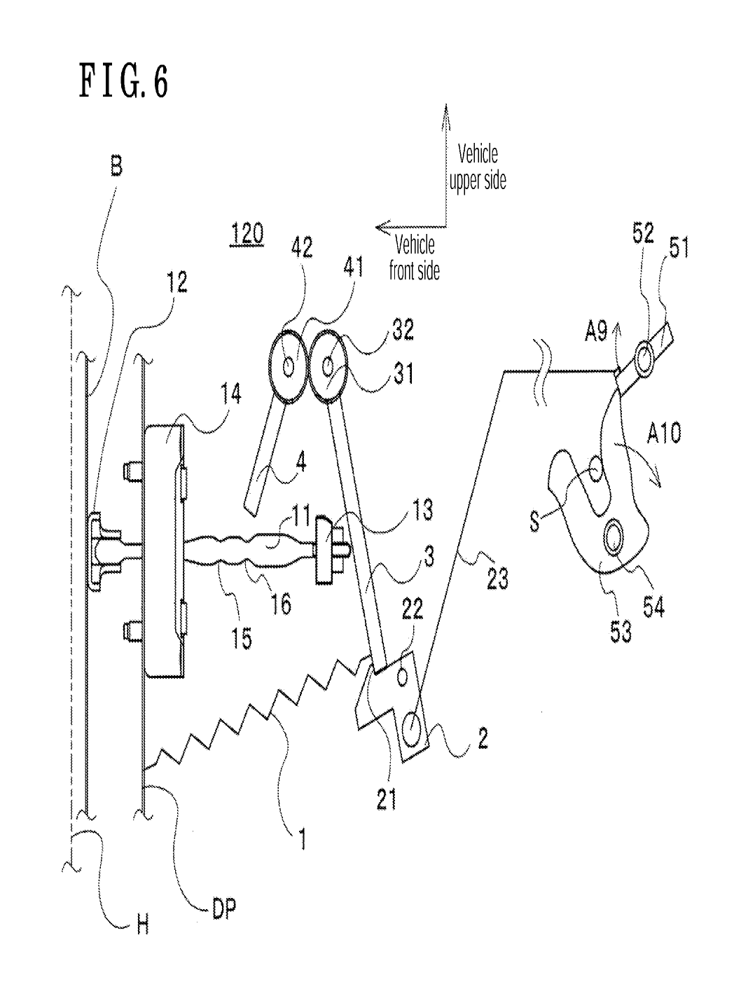

Further, in the present embodiment, it is configured that the pawl 2 is connected to the door handle 5 via the cable 23 and the pawl 2 rotates on the basis of the operation of the door handle 5. The construction for rotating the pawl 2 is not limited to the above. For example, a construction where the pawl 2 is connected to a pawl 51 of a door latch mechanism via the cable 23 may be employed. A construction of a pop-up mechanism 120 at this time is illustrated in FIG. 6. In the pop-up mechanism 120, the same constructions as those of the pop-up mechanism 100 bear the same reference numerals. In FIG. 6, the pawl 51 of the door latch mechanism is configured to rotate along an arrow A9 about a rotation shaft 52 based on the operation of the door handle. The pawl 51 engages with a door latch 53 that is fitted to a striker S. In a case where the pawl 51 rotates along the arrow A9, the door latch 53 rotates along an arrow A10 about a rotation shaft 54 to thereby release the fitting with the striker S. At this time, because the pawl 2 is connected to the pawl 51 of the door latch mechanism via the cable 23, the pawl 2 may rotate in association with the rotation of the pawl 51 of the door latch mechanism along the arrow A9 with the operation of the door handle by the user. Accordingly, the force stored by the spring 1 is released so that the door D is opened by the pop-up mechanism 120.

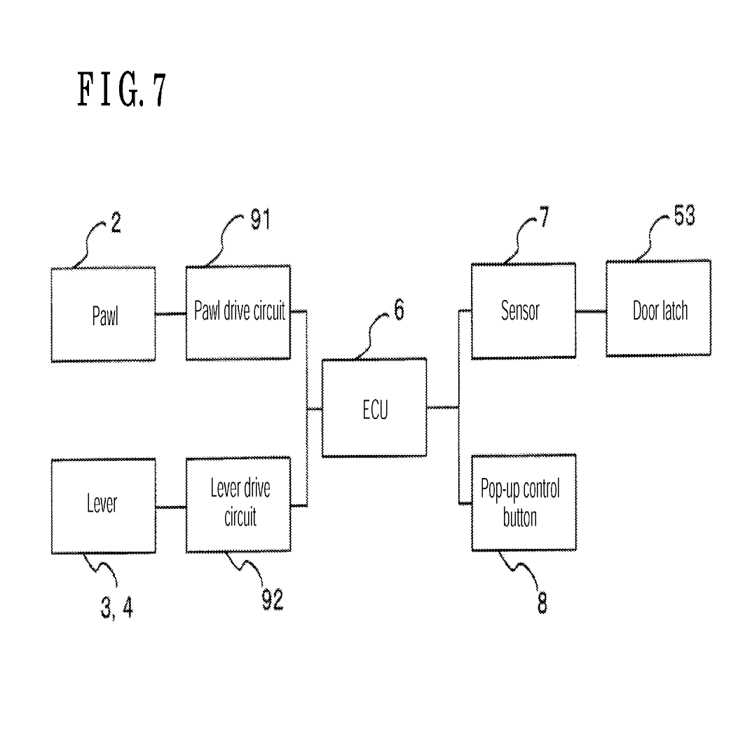

A portion of the operation of the pop-up mechanism 100 may be performed by a control of an actuator, for example. A construction at this time is illustrated in a block diagram of FIG. 7. An ECU 6 is a control portion including an ECU (Engine Control Unit) and a CPU (Central Processing Unit), for example, provided at the vehicle. A sensor 7 is a sensor detecting an engagement of the door latch 53 and a release thereof. A pop-up control button 8 is a button operated by the user for rotating the pawl 2. A pawl drive circuit 91 includes an actuator for driving the pawl 2. A lever drive circuit 92 includes an actuator for driving the first and second levers 3 and 4. According to the aforementioned construction, in a case where the sensor 7 detects the release of engagement of the door latch 53, a release detection signal is transmitted to the ECU 6. Based on the release detection signal from the sensor 7, the ECU 6 controls the pawl drive circuit 91 to thereby rotate the pawl 2. As a result, the door D is opened by the pop-up mechanism 100. Accordingly, the pawl 2 releases the force stored by the spring 1 based on the release of engagement of the door latch 53. Thus, in the aforementioned construction, the user may easily operate the door D because of the opening operation of the door D by the pop-up mechanism 100 by releasing the fitting of the door latch 53. In a case where the rotation of the pawl 2 is performed on a basis of an operation by the user, an opening operation instruction signal is transmitted to the ECU 6 from the pop-up control button 8 when the user operates the pop-up control button 8 provided at the door D, the vehicle, or a portable device, for example. The ECU 6 controls the pawl drive circuit 91 based on the aforementioned opening operation instruction signal to rotate the pawl 2 so as to cause the pop-up mechanism 100 to open the door D. That is, the user simply operates the pop-up control button 8 to thereby cause the pop-up mechanism 100 to open the door D, which leads to the easy operation of the door D. The pop-up control button 8 may include a button displayed on a touch panel display, for example, in addition to a mechanical button such as a switch and the like. The pop-up control button 8 may include a function for releasing the engagement of the door latch 53.

Further, in the first embodiment, the second lever 4 is configured to move by the stopper portion 13 of the check link 11. Alternatively, the second lever 4 may be configured to move by an actuator, for example, so as to store the force at the spring 1. For example, in a case where the sensor 7 detects the engagement of the door latch 53, the sensor 7 may transmit an engagement detection signal to the ECU 6. Then, the ECU 6 may control the lever drive circuit 92 based on the aforementioned engagement detection signal to move the second lever 4. At this time, the lever drive circuit 92 may be configured to directly move the first lever 3, instead of the second lever 4. In this case, it is understood that the second lever 4 and the first and second gears 31, 41 in the pop-up mechanism 100 according to the first embodiment may be omitted. The driving of the first or second lever 3, 4 may not be performed on a basis of the detection of the engagement of the door latch 53 and may be performed on a basis of the operation of the pop-up control button 8 by the user or the detection of movement of the door D, for example.

Further, a construction where the spring 1 is directly connected to the check link 11 that moves with the closing operation of the door D may be employed so that the force is stored at the spring 1. In this case, the pawl 2 is configured to hold the check link 11 at a predetermined position. In a case where the pawl 2 operates on a basis of the operation of the door handle 5, for example, the check link 11 causes the door D to open on a basis of the force stored by the spring 1. When the user thereafter closes the door D, the spring 1 extends with the operation of the check link 11. Because the pawl 2 holds the check link 11 at a position where the spring 1 extends, the force may be stored at the spring 1.

### Second Embodiment

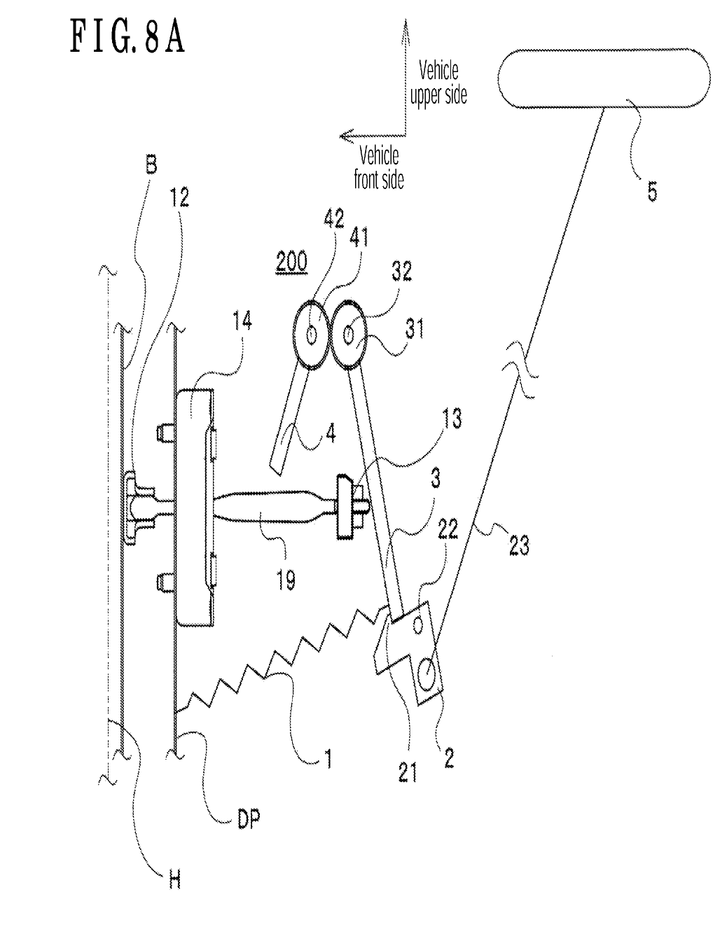

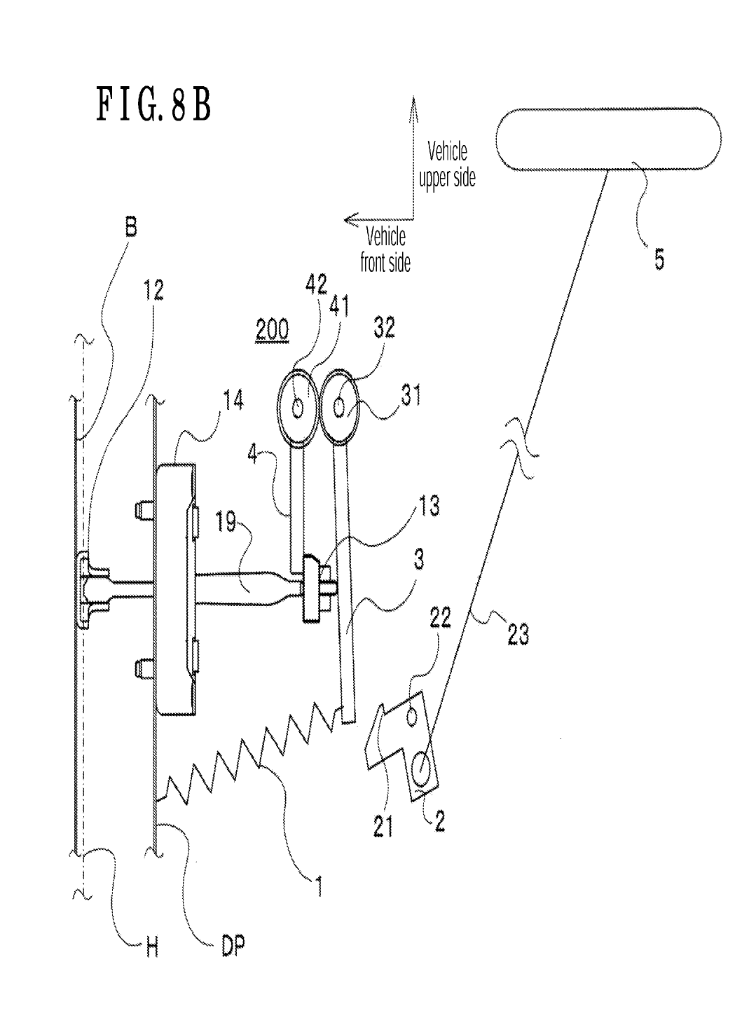

A pop-up mechanism 200 according to a second embodiment is explained with reference to FIGS. 8A and 8B. FIG. 8A illustrates the pop-up mechanism 200 according to the second embodiment in a case where the door D is arranged at the fully closed position. FIG. 8B illustrates the pop-up mechanism 200 according to the second embodiment after the door D is opened. In the pop-up mechanism 200, the same constructions as those of the pop-up mechanism 100 bear the same reference numerals. Here, the operations of the spring 1 and the like are substantially the same as the first embodiment and therefore a different point is mainly explained. In FIG. 8A, a check link 19 is configured to include a predetermined thickness. As is different from the first embodiment, the check link 19 is inhibited from including the grooves 15 and 16. Thus, as is different from the first embodiment, it is unable to hold the opening operation position of the door D by the engagement between the pressing body of the door check 14 and the groove on the check link.

In order to handle the above, as illustrated in FIG. 8B, it is configured that, after the opening operation of the door D by the pop-up mechanism 200, the stopper portion 13 of the check link 19 is sandwiched by the second lever 4 and the first lever 3. Because the stopper portion 13 of the check link 19 is sandwiched by the second lever 4 and the first lever 3, the operation position of the check link 19 is held so that the opening operation position of the door D is held at a position obtained after the pop-up operation. That is, without the groove provided at the check link, the opening operation position of the door D may be held by the pop-up mechanism 200 via the first and second levers 3 and 4. In a case where the user causes the door D to open or close after the pop-up operation of the door D, the first and second levers 3 and 4 move in an opposite direction from a direction where the first and second levers 3 and 4 sandwich the stopper portion 13 therebetween based on the operation of the check link 19. Thus, the operation of the door D is not interrupted. As a matter of course, in a case where the check link including the groove is utilized, the opening operation position of the door D may be also held by the pop-up mechanism by sandwiching the stopper portion of the check link by the first and second levers 3 and 4.

### Third Embodiment

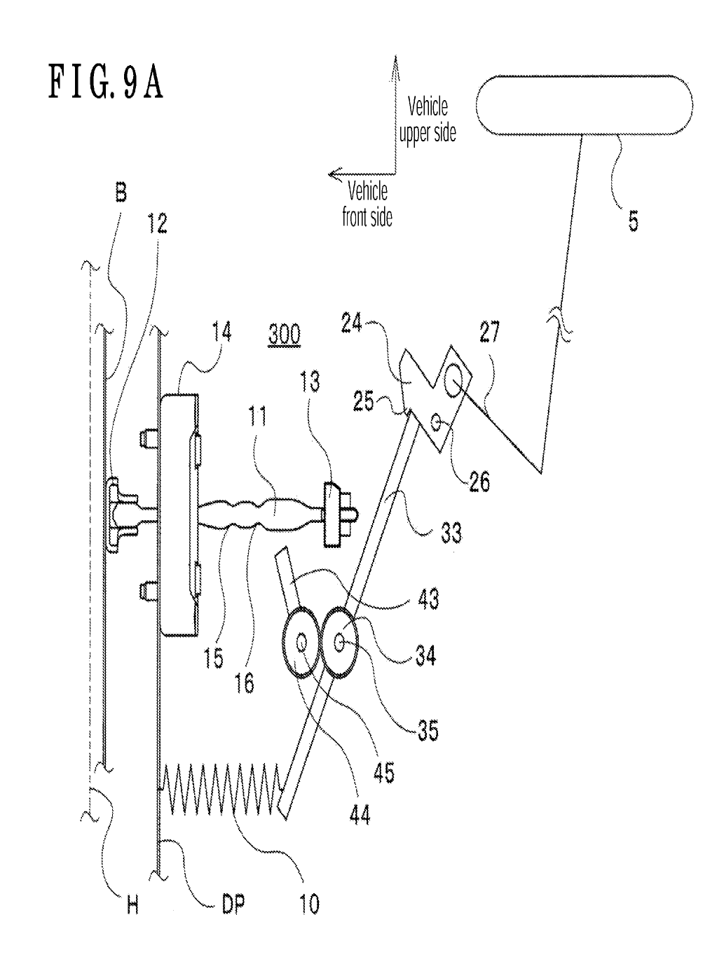

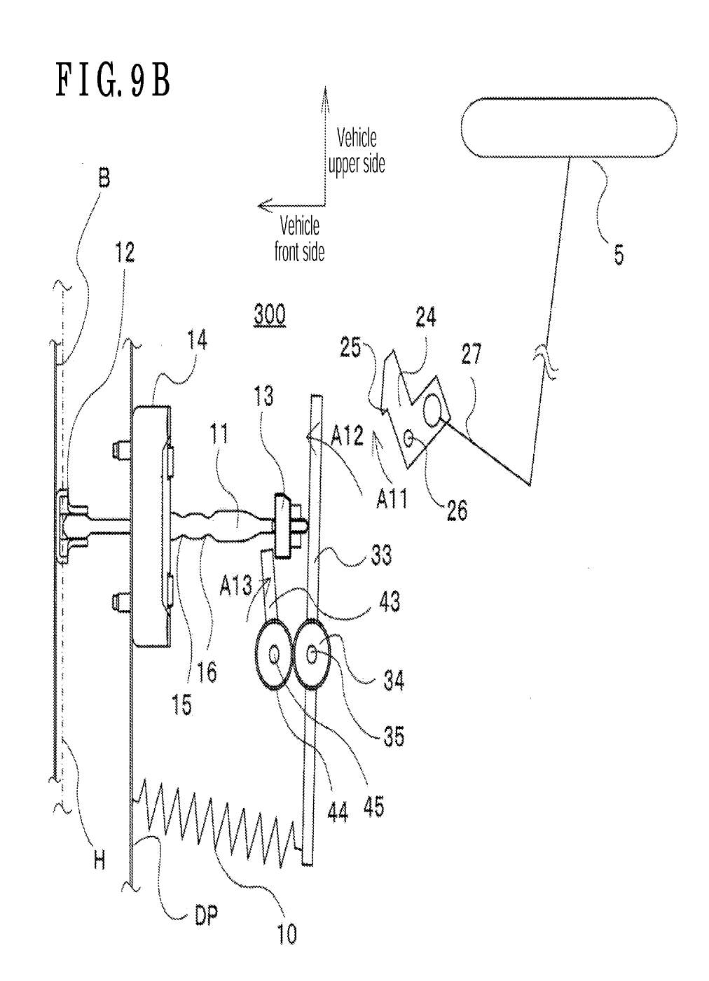

A pop-up mechanism 300 according to a third embodiment is explained with reference to FIGS. 9A and 9B. FIG. 9A illustrates the pop-up mechanism 300 according to the third embodiment in a case where the door D is arranged at the fully closed position. FIG. 9B illustrates an operation of the pop-up mechanism 300 according to the third embodiment. In the pop-up mechanism 300, the same constructions as those of the pop-up mechanism 100 bear the same reference numerals. Here, the operations of the check link 11 and the like are substantially the same as the first embodiment and therefore a different point is mainly explained. In the pop-up mechanism 100 of the first embodiment, the spring 1 is configured to store the force by extending. In the pop-up mechanism 300 of the present embodiment, a spring 10 is configured to store the force by contracting. The pop-up mechanism 300 includes the check link 11, the spring 10, a pawl 24, third and fourth levers 33, 43, and third and fourth gears 34, 44. The pawl 24 is connected to the door handle 5 via a cable 27 and is rotatable about a rotation shaft 26. The third and fourth gears 34 and 44 are rotatable about rotation shafts 35 and 45 respectively.

In FIG. 9A, the third lever 33 connected to the spring 10 is coupled to the third gear 34 and configured to rotate about the rotation shaft 35 of the third gear 34. The pawl 24 includes a projection piece 25 which is configured to fit to the third lever 33 so as to hold the third lever 33 at a predetermined position at which the spring 10 is compressed to store the force. The fourth gear 44 is arranged to mesh with the third gear 34. The fourth lever 43 is coupled to the fourth gear 44.

As illustrated in FIG. 9B, in the pop-up mechanism 300 of the third embodiment, in a case where the pawl 24 rotates about the rotation shaft 26 along an arrow A11 with the operation of the door handle 5, the fitting between the projection piece 25 of the pawl 24 and the third lever 33 is released. In a case where the fitting between the projection piece 25 and the third lever 33 is released, the spring 10 extends with the stored force, which moves the third lever 33 along an arrow Al2. The third lever 33 moves on the basis of the force stored by the spring 10 and makes contact with the stopper portion 13, which pushes the check link 11. The check link 11 which is pushed by the third lever 33 operates in the same way as the operation in the pop-up mechanism 100 according to the first embodiment to thereby open the door D. Accordingly, with the construction of the present embodiment, the user may also open the door D by the pop-up mechanism 300 and may easily operate the door. In association with the movement of the third lever 33, the third gear 34 rotates, which rotates the fourth gear 44 meshed with the third gear 34. In a case where the fourth gear 44 rotates, the fourth lever 43 coupled to the fourth gear 44 moves along an arrow A13. In a case where the door D is thereafter further opened by the user, the stopper portion 13 makes contact with the fourth lever 43, which moves the fourth lever 43 with the movement of the check link 11. When the fourth lever 43 moves, the operation of the fourth lever 43 is transmitted to the third lever 33 via the third and fourth gears 34 and 44. The third lever 33 moves to compress the spring 10 so that the spring 10 stores the force. Consequently, in the same way as the pop-up mechanism 100 of the first embodiment, the opening of the door D by the user may cause the spring 10 to store the force for the next pop-up operation of the door D. That is, the biasing of the spring 10 for the next opening operation of the door D by the pop-up mechanism 300 may be performed without the intension of the user.

The present invention has been explained with reference to the aforementioned embodiments. The present invention, however, is not limited to the aforementioned embodiments. Inventions which are changed without departing from the spirit of the present invention and inventions equivalent to the present invention are also included in the present invention. In addition, the aforementioned embodiments and modified examples may be appropriately combined without departing from the spirit of the invention.

The present application claims priority to Japanese Patent Application 2013-224058 filed on Oct. 29, 2013 and cites the contents thereof for constituting a portion of the present application.

### EXPLANATION OF REFERENCE NUMERALS

1, 10: spring (second member), 2, 24: pawl (trigger member), 3: first lever (first moving member), 4: second lever (second moving member), 5: door handle, 6: ECU, 7: sensor, 8: pop-up control button, 11, 19: check link (first member), 12: bracket, 13: stopper portion, 14: door check, 15, 16: groove, 17: pneumatic cylinder, 18: piston rod, 21, 25: projection piece, 22, 26: rotation shaft of pawl, 23, 27: cable, 31: first gear (transmission member), 32: rotation shaft of first gear, 33: third lever (first moving member), 34: third gear (transmission member), 35: rotation shaft of third gear, 41: second gear (transmission member), 42: rotation shaft of second gear, 43: fourth lever (second moving member), 44: fourth gear (transmission member), 45: rotation shaft of fourth gear, 51: pawl, 52: rotation shaft of pawl, 53: door latch, 54: rotation shaft of door latch, 91, 92: drive circuit (actuator), 100, 110, 120, 200, 300: pop-up mechanism, B: vehicle body, D: door, DP: door panel, H: hinge shaft, V: vehicle

1: A pop-up mechanism of a door for a vehicle, comprising:
a first member configured to be supported at a vehicle body and to transmit a force to a door for a vehicle;
a second member configured to store an external force applied to the second member and to transmit the force that is stored to the first member; and
a trigger member releasing the force stored by the second member,
the first member opening the door for the vehicle based on the force stored by the second member in a case where the trigger member releases the force stored by the second member.

2: The pop-up mechanism of the door for the vehicle according to claim 1, further comprising a first moving member connected to the second member, wherein the first moving member transmits the force stored by the second member to the first member by moving on a basis of the force stored by the second member to make contact with the first member in a case where the force stored by the second member is released.

3: The pop-up mechanism of the door for the vehicle according to claim 1, wherein the second member is applied with the external force based on an opening operation of the door for the vehicle.

4: The pop-up mechanism of the door for the vehicle according to either claim 1, wherein the second member is applied with the external force based on a closing operation of the door for the vehicle.

5: The pop-up mechanism of the door for the vehicle according to claim 1, further comprising a second moving member making contact with the first member at a predetermined position and moving on a basis of an operation of the first member, wherein the second member is applied with the external force based on the movement of the second moving member.

6: The pop-up mechanism of the door for the vehicle according to claim 5, further comprising a transmission member transmitting, to the first moving member and the second moving member, each other's operation of the first moving member and the second moving member, wherein
the first moving member moves by an operation of the second moving member transmitted to the first moving member via the transmission member,
the second member is applied with the external force based on the movement of the first moving member.

7: The pop-up mechanism of the door for the vehicle according to claim 5, wherein an opening operation position of the door for the vehicle is held in a state where an end portion of the first member that extends within the door for the vehicle is sandwiched by the first moving member and the second moving member after the first member opens the door for the vehicle.

8: The pop-up mechanism of the door for the vehicle according to claim 2, wherein the second member connected to the first member is applied with the external force in a state where the first member pushes the first moving member.

9: The pop-up mechanism of the door for the vehicle according to claim 2, further comprising an actuator which moves the first moving member, wherein the second member connected to the first member is applied with the external force in a state where the actuator moves the first moving member.

10: The pop-up mechanism of the door for the vehicle according to claim 1, wherein the trigger member releases the force stored by the second member based on an operation of one of a door handle and a pawl of a door latch mechanism.

11: The pop-up mechanism of the door for the vehicle according to claim 1, wherein the trigger member releases the force stored by the second member based on a release of an engagement of a door latch of the door for the vehicle.

12: The pop-up mechanism of the door for the vehicle according to claim 1, wherein the trigger member releases the force stored by the second member based on an operation of a pop-up operation button.

13: The pop-up mechanism of the door for the vehicle according to claim 1, wherein the first member is a check link.
